(19) United States
(12) Patent Application Publication
(10) Pub. No.: US 2025/0045953 A1
(43) Pub. Date: Feb. 6, 2025

(54) ASSOCIATION MATCHING METHOD AND ASSOCIATION MATCHING SYSTEM

(71) Applicant: Wistron Corporation, New Taipei City (TW)

(72) Inventors: Jiun-In Guo, Hsinchu (TW); Yao-Syuan Lee, Hsinchu (TW)

(73) Assignee: Wistron Corporation, New Taipei City (TW)

(21) Appl. No.: 18/470,451

(22) Filed: Sep. 20, 2023

(30) Foreign Application Priority Data
Jul. 26, 2023 (TW) 112128019

(51) Int. Cl. G06T 7/73

(52) U.S. Cl. CPC G06T 7/74; G06T 2207/30232

(57) ABSTRACT

An association matching method and an association matching system are provided. In the method, first reference coordinates of a first reference position in a first image on a first local map are determined, and second reference coordinates of a second reference position in a second image on a second local map are determined. The first local map and the second local map are mapped to a global map. The first reference coordinates of the first reference position and/or the second reference coordinates of the second reference position is mapped to coordinates on the global map according to a conversion relationship. The conversion relationship is corrected according to coordinates of third reference positions in one or more third images and fourth reference positions in one or more fourth images mapped to the global map through the conversion relationship. Thus, the performance of object matching may be improved.

### CROSS-REFERENCE TO RELATED APPLICATION

This application claims the priority benefit of Taiwan application serial no. 112128019, filed on Jul. 26, 2023. The entirety of the above-mentioned patent application is hereby incorporated by reference herein and made a part of this specification.

### BACKGROUND

### Technical Field

The disclosure relates to an image processing technique, and more particularly, to an association matching method and an association matching system.

### Description of Related Art

In the entire development of a smart city, sensors distributed at various intersections play a crucial role. These sensors can instantly detect local information, enabling the system to analyze and grasp the overall situation and even implement responsive measures. By leveraging communication technology for data transmission, a large number of sensors can be installed to extend the monitoring view of field to more areas. If camera devices are equipped with embedded platforms capable of computation, they can not only provide image feedback signals but also extract more valuable information through various post-processing techniques, thereby reducing the burden on servers.

Existing single-camera object detection and tracking technologies have made significant progress. However, for larger areas such as intersections, a single-camera cannot detect the entire region. In practical applications, objects may be shaded, leading to the loss of their positional information. Thus, an effective multi-camera target tracking related technology with overlapping field of view is essential.

However, in terms of positional information, conventional multi-camera object tracking monitoring systems only record the order of the number of the camera that record the appearance of the objects, without obtaining precise positional information for each object that appear in each frame.

In addition, conventional multi-camera object tracking monitoring systems utilize visual information such as color and appearance of the image for matching objects across multiple cameras, but these matching criteria can be affected by factors such as lighting conditions and changes in the object's perspective, which may negatively impact the matching accuracy.

### SUMMARY

The disclosure provides an association matching method and an association matching system, which utilizes relative reference coordinates for target association to reduce the impact of appearance features.

The association matching method in the embodiment of the disclosure is described below, but is not limited thereto. First reference coordinates of a first reference position in a first image on a first local map are determined. Second reference coordinates of a second reference position in a second image on a second local map are determined. The first image is obtained through a first image capturing device, and the second image is obtained through a second image capturing device. The first local map and the second local map are mapped to a global map. The first reference coordinates of the first reference position and/or the second reference coordinates of the second reference position is mapped to coordinates on the global map according to a conversion relationship. The conversion relationship is corrected according to coordinates of third reference positions in one or more third images and fourth reference positions in one or more fourth images mapped to the global map through the conversion relationship. The third image is obtained through the first image capturing device, and the fourth image is obtained through the second image capturing device. The corrected conversion relationship minimizes a miss distance between the coordinates of the third reference position mapped to the global map and the coordinates of the fourth reference position mapped to the global map.

The association matching system in the embodiment of the disclosure includes (but is not limited to) a computing device. The computing device determines first reference coordinates of a first reference position in a first image on a first local map and second reference coordinates of a second reference position in a second image on a second local map and maps the first local map and the second local map to a global map. The conversion relationship is corrected according to coordinates of third reference positions in one or more third images and fourth reference positions in one or more fourth images mapped to the global map through the conversion relationship. The first image is obtained through a first image capturing device, and the second image is obtained through a second image capturing device. The first reference coordinates of the first reference position and/or the second reference coordinates of the second reference position is mapped to coordinates on the global map according to a conversion relationship. The third image is obtained through the first image capturing device, and the fourth image is obtained through the second image capturing device. The corrected conversion relationship minimizes a miss distance between the coordinates of the third reference position mapped to the global map and the coordinates of the fourth reference position mapped to the global map.

Based on the above, the association matching method and the association matching system in the embodiment of the disclosure may convert the two reference coordinates corresponding to the same object captured by the two image capturing devices into the coordinates on the global map and adjust the conversion relationship from the local map to the global map according to other reference coordinates. In this way, the impact of lighting conditions and changes in viewing angles on the appearance features matching may be reduced, thereby enhancing the efficiency of object tracking.

In order to make the above-mentioned features and advantages of the disclosure comprehensible, embodiments accompanied with drawings are described in detail below.

### BRIEF DESCRIPTION OF THE DRAWINGS

FIG. 1 is an element block diagram of an association matching system according to an embodiment of the disclosure.

FIG. 2 is a flowchart of an association matching method according to an embodiment of the disclosure.

FIG. 3A is a schematic diagram of the position relationship in a top view according to an embodiment of the disclosure.

FIG. 3B is a schematic diagram of the first image according to an embodiment of the disclosure.

FIG. 3C is a schematic diagram of the second image according to an embodiment of the disclosure.

FIG. 4A is a schematic diagram of the position relationship in a top view according to another embodiment of the disclosure.

FIG. 4B is a schematic diagram of the first image according to another embodiment of the disclosure.

FIG. 4C is a schematic diagram of the second image according to another embodiment of the disclosure.

FIG. 5 is a schematic diagram from the pixel coordinates to the coordinates on the local map, according to an embodiment of the disclosure.

FIG. 6A is a schematic diagram of the first local map according to an embodiment of the disclosure.

FIG. 6B is a schematic diagram of the second local map according to an embodiment of the disclosure.

FIG. 7A is a schematic diagram of the third image according to an embodiment of the disclosure.

FIG. 7B is a schematic diagram of the fourth image according to an embodiment of the disclosure.

### DESCRIPTION OF THE EMBODIMENTS

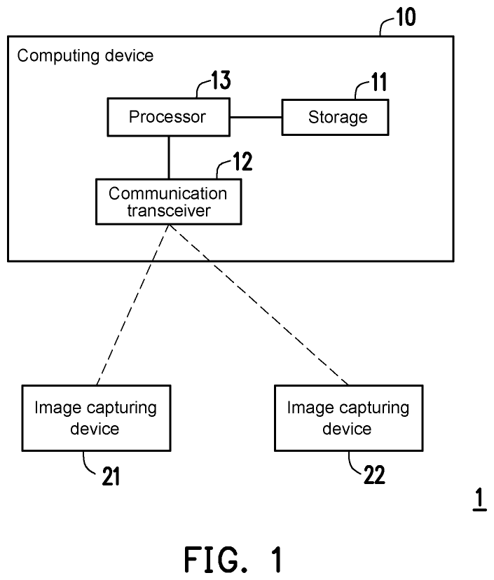

FIG. 1 is an element block diagram of an association matching system 1 according to an embodiment of the disclosure. Referring to FIG. 1, the association matching system 1 includes (but not limited to) a computing device 10 and image capturing devices 21 and 22. The association matching system 1 may be applied in application scenarios such as traffic, indoor, exercise, or military.

The computing device 10 may be a smartphone, a tablet computer, a server, a cloud host, a computer host, a wearable device, or other electronic devices. The computing device 10 includes (but not limited to) a storage 11, a communication transceiver 12, and a processor 13.

The storage 11 may be any type of fixed or movable random access memory (RAM), read only memory (ROM), flash memory, conventional hard disk drive (HDD), solid-state drive (SSD) or similar components. In one embodiment, the storage 11 is used to store codes, software modules, configurations, data (e.g., image, coordinates, or conversion relationship), or files, and the embodiment is to be described later.

The communication transceiver 12 may support various communication technologies such as fourth-generation (4G) or other generations of mobile communication, Wi-Fi, Bluetooth, infrared, radio frequency identification (RFID), Ethernet, optical fiber networks, as well as serial communication interfaces (e.g., RS-232). It may also be universal serial bus (USB), Thunderbolt, or other communication transmission interfaces. In one embodiment, the communication transceiver 12 is used to transmit or receive data with other electronic devices (e.g., image capturing devices 21, 22).

The processor 13 is coupled to the storage 11 and the communication transceiver 12. The processor 13 may be a central processing unit (CPU), a graphics processing unit (GPU), or other programmable general-purpose or special-purpose microprocessors, a digital signal processor (DSP), a programmable controller, a field programmable gate array (FPGA), an application-specific integrated circuit (ASIC), a neural network accelerator, or other similar components, or combinations of components thereof. In one embodiment, the processor 13 is used to execute all or some of the operations of the computing device 10, and may load and execute various codes, software modules, files, and data stored in the storage 11. In some embodiments, the functions of the processor 13 may be realized by software or chips.

The image capturing devices 21 and 22 may be cameras, video cameras, monitors, smartphones, or road side units (RSU) with image capturing function, and may capture one or more images in the specified field of view accordingly.

In some embodiments, any one of the image capturing devices 21 and 22 may be integrated with the computing device 10 to form an independent device. It should be noted that FIG. 1 shows two image capturing devices 21 and 22 as an example, but the amount is not limited thereto.

In the following, the method mentioned in the embodiment of the disclosure will be illustrated with each device, element, and module in the association matching system 1. Each flow of this method may be adjusted according to the implementation situation.

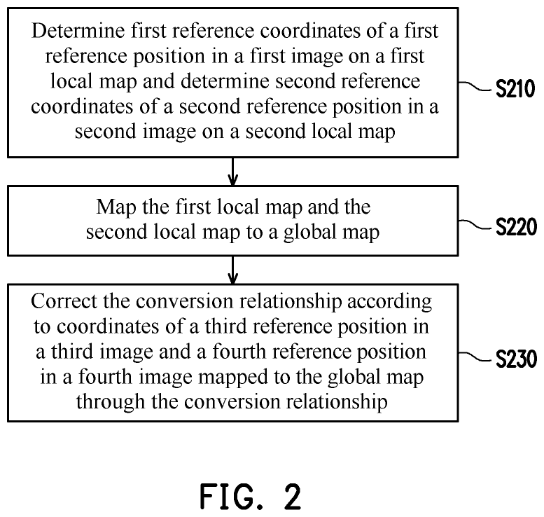

FIG. 2 is a flowchart of an association matching method according to an embodiment of the disclosure. Referring to FIG. 2, the processor 13 determines first reference coordinates of a first reference position in a first image on a first local map and determines second reference coordinates of a second reference position in a second image on a second local map (step S210). Specifically, the first image is obtained through the image capturing device 21, and the second image is obtained through the image capturing device 22. The time for shooting the first image and the second image may be at the same time or separated by an allowable period (e.g., 50 milliseconds (ms), 100 ms, or 500 ms). The first reference position is the position of the object in the first image, and the second reference position is the position of the same object in the second image. The object may be a person, an animal, a vehicle, a machine, a building, or other specific object. In one embodiment, for a single frame image, the object detection technology may be used to identify the object. There are many algorithms for object detection, such as YOLO (You Only Look Once), SSD (Single Shot Detector), or R-CNN, but are not limited thereto. The detection result of the object may be the representative information of the object, such as an object type, a bounding box, an identifier, and/or coordinates. In another embodiment, the first reference position and the second reference position may also be the positions in the first image and/or the second image specified by the input operation of the user. For example, the touch screen receives a touch operation at a specific position, or the mouse receives an operation of moving to a specific position and clicking.

In one embodiment, the processor 13 may define that a field of view of the image capturing device 21 partially overlaps a field of view of the image capturing device 22. The field of view refers to the range of scenes that may be captured by the image capturing devices 21 and 22. Since the first reference position and the second reference position are for the same object in the first image and the second image, at least a part of the field of view of the two image capturing devices 21 and 22 overlaps. However, based on the hardware specification of the image capturing devices 21, 22 (e.g., the focal length or viewing angle of the lens, or the size of the photosensitive element) and the application scenario (e.g., the environment or task content), the size and shape of the overlapping area of the two field of views may be different.

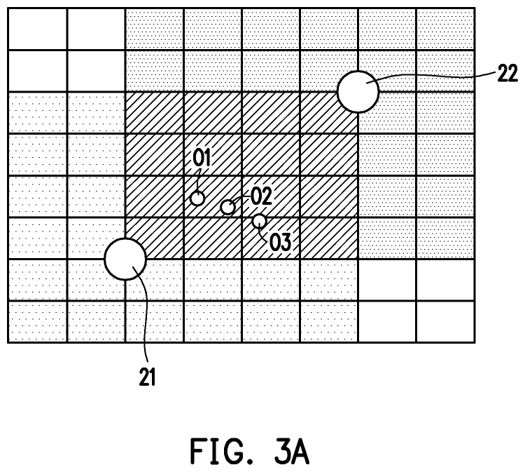

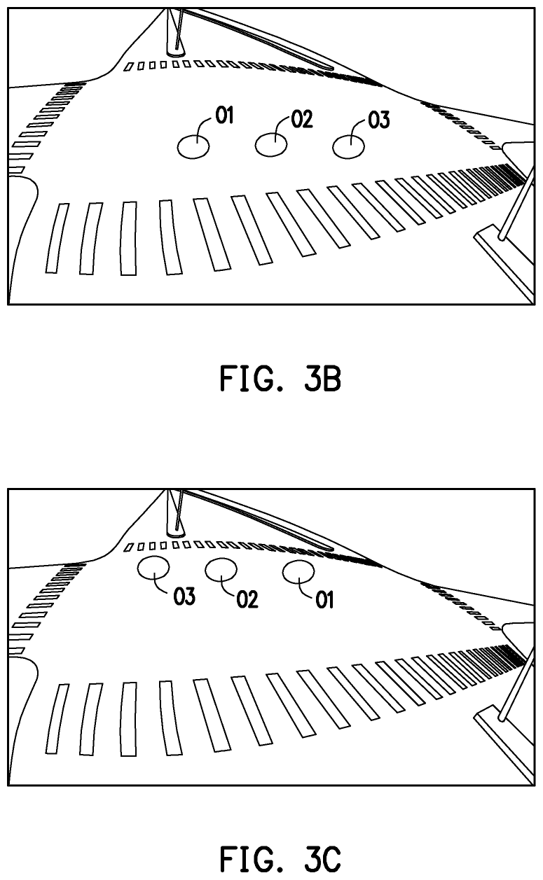

In one embodiment, the image capturing device 21 is located in the field of view of the image capturing device 22, and the image capturing device 22 is located in the field of view of the image capturing device 21. The field of view may be adjusted by changing the shooting orientation, lens specification, image cropping, or in other manners. Thus, the image capturing device 22 is located in the first image captured by the image capturing device 21, and the image capturing device 21 is located in the second image captured by the image capturing device 22. For example, FIG. 3A is a schematic diagram of the position relationship in a top view according to an embodiment of the disclosure. Referring to FIG. 3A, the image capturing devices 21 and 22 (e.g., road side units) are provided at two opposite corners of an intersection. The image capturing devices 21 and 22 shoot towards each other, so that the overlapping field of view of the image capturing devices 21 and 22 roughly covers the intersection (as indicated by the diagonal-line-shaded region in the figure). It should be noted that the field of view in FIG. 3A is only used as an example, and the shape, size, position, and configuration environment may be modified. For example, the image capturing devices 21 and 22 are monitors of stores, halls, or parking lots, and may be configured at any position in the field.

FIG. 3B is a schematic diagram of the first image according to an embodiment of the disclosure. Referring to FIG. 3A and FIG. 3B, the first image obtained by the image capturing device 21 includes three objects O1, O2, and O3 in the overlapping field of view.

FIG. 3C is a schematic diagram of the second image according to an embodiment of the disclosure Referring to FIG. 3A and FIG. 3C, the second image obtained by the image capturing device 22 includes the three objects O1, O2, and O3 in the overlapping field of view. That is, when the objects O1, O2, and O3 are located in the overlapping field of view, both the first image and the second image include the image of the objects O1, O2, and O3.

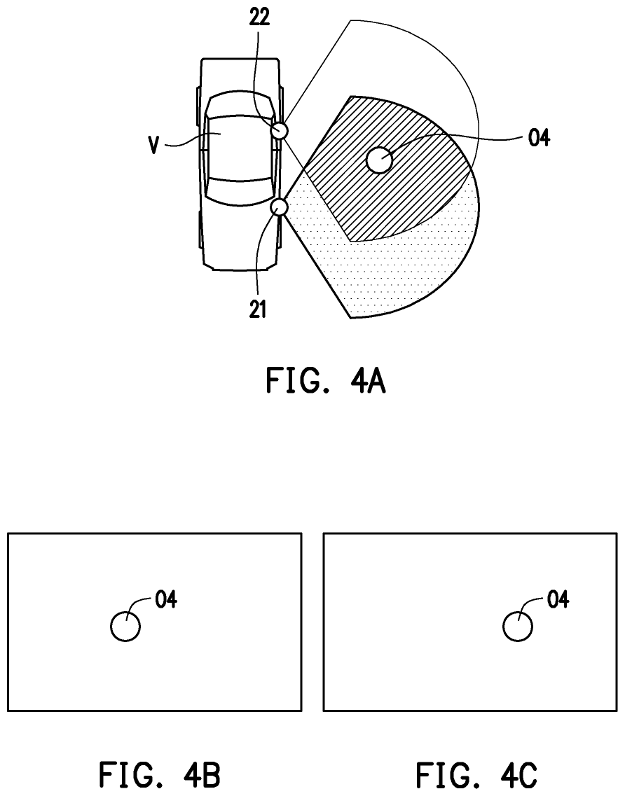

In another embodiment, the image capturing device 22 is not located in the field of view of the image capturing device 21, and the image capturing device 21 is not located in the field of view of the image capturing device 22. The field of view may be adjusted by changing the shooting orientation, lens specification, image cropping, or in other manners. Thus, the image capturing device 22 is not located in the first image captured by the image capturing device 21, and the image capturing device 21 is not located in the second image captured by the image capturing device 22. For example, FIG. 4A is a schematic diagram of the position relationship in a top view according to another embodiment of the disclosure. Referring to FIG. 4A, both the image capturing devices 21 and 22 are located on one side of a mobile vehicle V (e.g., a car, a motorbike, or a bus). The image capturing devices 21 and 22 shoot in the same direction, so that the overlapping field of view of the image capturing devices 21 and 22 is roughly located in the diagonal-line-shaded region in the figure. It should be noted that the field of view in FIG. 4A is only used as an example, and the shape, size, position, and configuration environment may be modified. For example, the image capturing devices 21 and 22 are monitors of stores, halls, or parking lots, and may be configured at any position in the field.

FIG. 4B is a schematic diagram of the first image according to another embodiment of the disclosure. Referring to FIG. 4A and FIG. 4B, the first image obtained by the image capturing device 21 includes an object O4 in the overlapping field of view.

FIG. 4C is a schematic diagram of the second image according to another embodiment of the disclosure. Referring to FIG. 4A and FIG. 4C, the second image obtained by the image capturing device 22 includes the object O4 in the overlapping field of view. That is, when the object O4 is located in the overlapping field of view, both the first image and the second image include the image of the object O4.

On the other hand, the coordinates of the first local map are defined by the relative distance to the image capturing device 21, and the coordinates of the second local map is defined by the relative distance to the image capturing device 22. The two local maps include the local coordinate system established by the vertical axis and the horizontal axis. The relative distance includes vertical distance and horizontal distance. Taking the position of the image capturing device 21 as the origin of the vertical axis and the horizontal axis, the vertical axis corresponds to the vertical distance relative to the position of the image capturing device 21, and the horizontal axis corresponds to the horizontal distance relative to the position of the image capturing device 21. Similarly, taking the position of the image capturing device 22 as the origin of the vertical axis and the horizontal axis, the vertical axis corresponds to the vertical distance relative to the position of the image capturing device 22, and the horizontal axis corresponds to the horizontal distance relative to the position of the image capturing device 22.

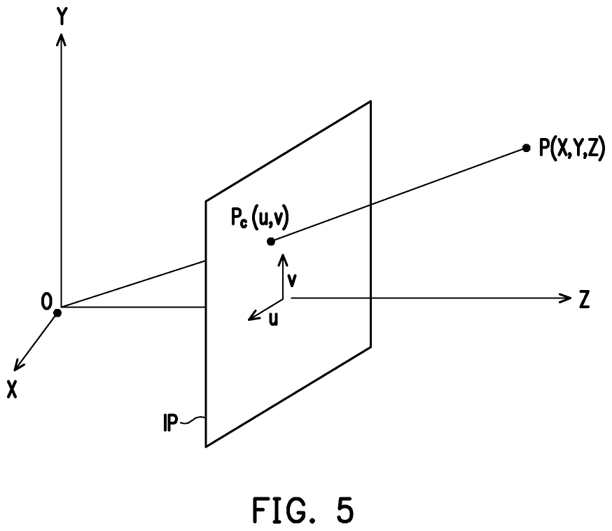

In one embodiment, the processor 13 may convert the pixel coordinates of the first reference position in the first image into the first reference coordinates and/or convert the pixel coordinates of the second reference position in the second image to the second reference coordinates through a pinhole camera model. Specifically, FIG. 5 is a schematic diagram from the pixel coordinates (u, v) to the coordinates (x, y, z) on the local map, according to an embodiment of the disclosure. Referring to FIG. 5, the local/world coordinate system includes an X axis, a Y axis, and a Z axis. The image coordinate system includes a U axis and a V axis. The image capturing device 21 or 22 is located at the origin O of the local coordinate system. It is assumed that the coordinates of an object P in the local coordinate system are (x, y, z). The pinhole camera model projects an object in the three-dimensional world onto a two-dimensional image plane IP through an ideal pinhole camera (with an infinitely small pinhole aperture), and its mathematical expression is:

$$\\ \begin{matrix}[ \begin{matrix}u \\ v \\ 1\end{matrix} ] = [ \begin{matrix}{f}_{x} & s & {O}_{x} \\ 0 & {f}_{y} & {O}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] & ( 1 )\end{matrix}$$

(x, y, z) are the x, y, z coordinates of the position of the object P described according to the local/world coordinate system. (u, v) are the pixel coordinates of a projection point P_{c} in units of pixels. fₓ and f_{y} are the numbers of pixels of the focal length in the U axis direction and the V axis direction, respectively. Ox and Oy are the numbers of displacement pixels of the origin O in the U axis direction and the V axis direction, respectively (i.e., the pixel coordinates of the origin O in the local coordinate system on the image plane IP). r₁₁˜r₃₃ are the elements in the rotation matrix for the conversion from the local/world coordinate system to the camera coordinate system. t₁˜t₃ are the elements in the translation vector for the conversion from the local/world coordinate system to the camera coordinate system. s (optional) is a skew parameter suitable for scenarios where the U axis and the V axis are not perpendicular. Except for the coordinates (x, y, z) and (u, v), other parameters may be stored in the storage 12 for use by the processor 13. Then, coordinates (u, v) are substituted into equation (1) to obtain the coordinates (x, y, z). That is, the first reference coordinates are obtained by converting the pixel coordinates of the first reference position in the first image through equation (1), and the second reference coordinates are obtained by converting the pixel coordinates of the second reference position in the second image through equation (1).

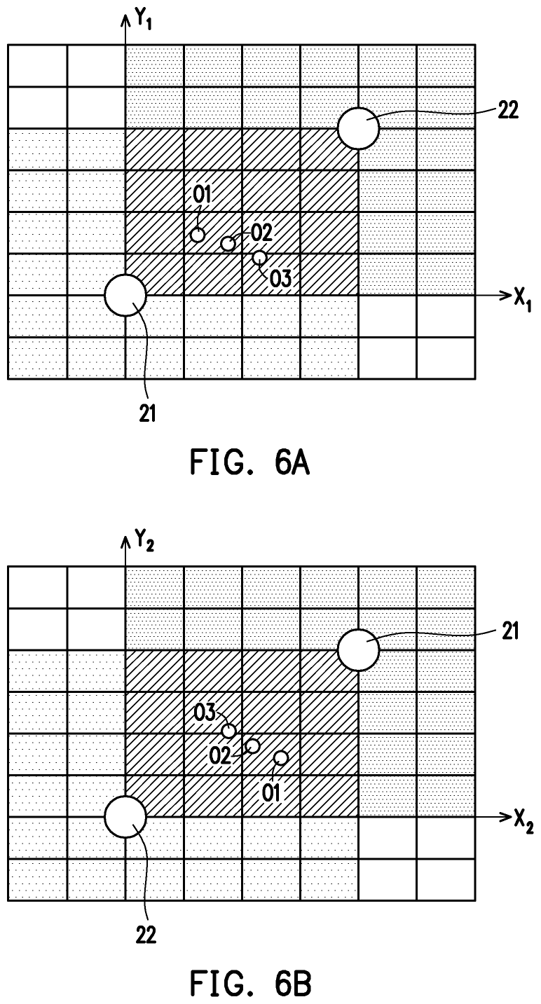

FIG. 6A is a schematic diagram of the first local map according to an embodiment of the disclosure. Referring to FIG. 3B and FIG. 6A, the first local map includes an X₁ axis and a Y₁ axis (corresponding to the X axis and the Y axis of the aforementioned local/world coordinate system respectively). In FIG. 3B, the pixel coordinates of the first reference positions of the objects O1˜O3 in the first image may be converted into the coordinates of the X₁ axis and the Y₁ axis (ignoring the coordinate of the Z axis).

FIG. 6B is a schematic diagram of the second local map according to an embodiment of the disclosure. Referring to FIG. 3C and FIG. 6B, the second local map includes an X₂ axis and a Y₂ axis (corresponding to the X axis and the Y axis of the aforementioned local/world coordinate system respectively). In FIG. 3C, the pixel coordinates of the second reference positions of the objects O1˜O3 in the second image may be converted into the coordinates of the X₂ axis and the Y₂ axis (ignoring the coordinate of the Z axis).

The pinhole camera model is an assumed ideal imaging model, but the lens imaging may be distorted, such as radial and tangential distortions. In one embodiment, based on the lens specification of the image capturing devices 21 and 22, the processor 13 may perform distortion correction on the first reference coordinates and/or the second reference coordinates. For example, the radial and tangential distortions are described through the corresponding distortion parameters, and the correction equation is derived accordingly. The processor 13 may substitute the first reference coordinates and/or the second reference coordinates into the correction equation to correct the first reference coordinates and/or the second reference coordinates.

In some embodiments, the processor 13 may further determine the first reference coordinates of the first reference positions corresponding to more objects in the first image on the first local map and the second reference coordinates of the second reference positions corresponding to more objects in the second image on the second local map.

Referring to FIG. 2, the processor 13 maps the first local map and the second local map to a global map (step S220). Specifically, the coordinate system of the global map also adopts the world coordinate system, that is, the coordinates are defined by the X axis corresponding to the horizontal direction and the Y axis corresponding to the vertical direction. The local coordinate systems used by the first local map and the second local map are defined by the relative positions relative to the two image capturing devices 21 and 22, respectively. Then, the two local coordinate systems are mapped to the same global coordinate system to match the reference coordinates of the two objects.

In one embodiment, at least one of the first reference coordinates of the first reference position and the second reference coordinates of the second reference position is mapped to the coordinates on the global map according to the conversion relationship. It is worth noting that the coordinate conversion of different coordinate systems may be achieved by rotation and/or translation of the coordinates. The conversion relationship refers to how the coordinates are rotated and/or translated. For example, it may involve rotating clockwise by 30 degrees and translating three units to the right, or rotating counterclockwise by 90 degrees and translating one unit upwards.

In one embodiment, the processor 13 may define the first local map as a reference map. That is, the local coordinate system of the first local map is used as the global coordinate system. The first reference coordinates are the coordinates of the first reference position on the global map. Then, the processor 13 may determine the conversion relationship of the second reference coordinates converting to the first reference coordinates on the reference map. The first reference position and the second reference position are the positions of the same object in the first image and the second image, respectively. Thus, the coordinates of the second reference coordinates of the second reference position on the second local map mapped to the reference map through the conversion relationship are the same as the first reference coordinates. The processor 13 may determine how the second reference coordinates are rotated and/or translated to be equivalent to the first reference coordinates.

In one embodiment, the conversion relationship refers to the conversion matrix. As mentioned above for the pinhole camera model, the conversion matrix may be used for the conversion of different coordinate systems. The conversion matrix may include a rotation matrix and/or a translation vector. The mathematical expression of the conversion matrix is:

$$\\ \begin{matrix}[ \begin{matrix}x 2 \\ y 2\end{matrix} ] = [ \begin{matrix}cos θ & - sin θ \\ sin θ & cos θ\end{matrix} ] [ \begin{matrix}x 1 \\ y 1\end{matrix} ] + [ \begin{matrix}Tx \\ Ty\end{matrix} ] & ( 2 )\end{matrix}$$

(x1, y1) are the first reference coordinates. (x2, y2) are the second reference coordinates.

$$\\ [ \begin{matrix}cos θ & - sin θ \\ sin θ & cos θ\end{matrix} ]$$

is the rotation matrix. θ is the rotation angle.

$$\\ [ \begin{matrix}Tx \\ Ty\end{matrix} ]$$

is the translation vector. Tx is the translation amount of the X axis. Ty is the translation amount of the Y axis.

In one embodiment, the processor 13 may substitute the first reference coordinates and second reference coordinates of multiple objects into equation (2) to calculate θ, Tx, and Ty. That is, solving the unknown variables in the simultaneous equations. In another embodiment, the processor 13 may assume the values for θ, Tx, and Ty and approximate the other one of the first reference coordinates and the second reference coordinates by substituting one of the first reference coordinates and the second reference coordinates into the equations and changing the values of θ, Tx, and Ty.

In another embodiment, the conversion relationship refers to a conversion lookup table or a conversion equation. The processor 13 may query the first reference coordinates corresponding to the second reference coordinates from the conversion lookup table, or substitute the second reference coordinates into the conversion equation to obtain the first reference coordinates.

In another embodiment, the conversion relationship includes the first conversion relationship and the second conversion relationship. The first reference coordinates of the first reference position may be mapped to the coordinates on the global map according to the first conversion relationship, and the second reference position may be mapped to the coordinates on the global map according to the second conversion relationship. That is, the first conversion relationship refers to how the coordinates of the first local map are rotated and/or translated, and the second conversion relationship refers to how the coordinates of the second local map are rotated and/or translated. Similarly, the first conversion relationship and the second conversion relationship may be obtained by calculating the aforementioned conversion matrix, the conversion lookup table, and/or the conversion equation.

Referring to FIG. 2, the processor 13 corrects the conversion relationship according to coordinates of third reference positions in one or more third images and fourth reference positions in one or more fourth images mapped to the global map through the conversion relationship (step S230). Specifically, the one or more third images are obtained through the image capturing device 21, and the one or more fourth images are obtained through the image capturing device 22. The image capturing devices 21 and 22 may capture the third image and the fourth image at the same time or with a time interval between corresponding frames within an allowable period (e.g., 50 ms, 100 ms, or 500 ms). The third reference position is the position of the object in the third image, and the fourth reference position is the position of the same object in the fourth image. The object may be a person, an animal, a vehicle, a machine, a building, or other specific object.

In one embodiment, the processor 13 may identify an object in the one or more third images and the one or more fourth images through the object detection technology or the marking by the input operation. The position of the object on the third image is defined as the third reference position, and the position of the object on the fourth image is defined as the fourth reference position. Similarly, as described in step S210, the reference position of the same object may be marked through object detection technology or the input operation of the user.

The conversion relationship obtained in step S220 may have errors. For the same object, different coordinates may be obtained from the conversion relationship obtained in step S220 for the pixel position of the third reference position and/or the fourth reference position. The distance between these two coordinates may be defined as a miss distance. Thus, further correction of this conversion relationship is required. The corrected conversion relationship may minimize a miss distance between the coordinates of the third reference position mapped to the global map and the coordinates of the fourth reference position mapped to the global map.

In one embodiment, the processor 13 may define a target function according to the miss distance. For example, the distance between the third reference coordinates and the fourth reference coordinates of a single object at a certain time point is defined as the target function. For another example, the distance between the third reference coordinates and the fourth reference coordinates of a single object at multiple time points is defined as the target function. The third reference coordinates are the coordinates of the pixel coordinates of the third reference position in the third image mapped to the global map through the conversion relationship obtained in step S220, and the fourth reference coordinates are the coordinates of the pixel coordinates of the fourth reference position in the fourth image mapped to the global map through the conversion relationship obtained in step S220.

The processor 13 may minimize the target function to determine the corrected conversion relationship. Taking equation (2) as an example, where θ, Tx, and Ty are unknown variables, the values of θ, Tx, and Ty are estimated using the least squares method or other regression algorithms. Alternatively, the target function is minimized through substituting different values of θ Tx, and Ty.

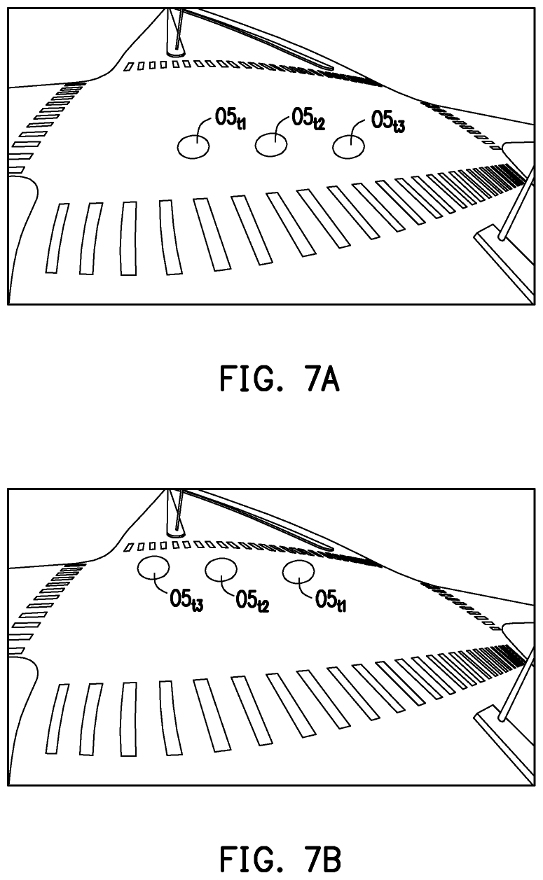

In one embodiment, the third images include third images at multiple time points, and the fourth images include fourth images at multiple time points. For example, FIG. 7A is a schematic diagram of the third image according to an embodiment of the disclosure, and FIG. 7B is a schematic diagram of the fourth image according to an embodiment of the disclosure. Referring to FIG. 7A and FIG. 7B, the reference positions of the same object at three time points t1, t2, and t3 are O5t₁, O5t₂, and O5t₃. The image capturing devices 21 and 22 may record videos synchronously to generate the third images and the fourth images of multiple time points, respectively.

The processor 13 may define the target function according to a sum of the miss distance between two coordinates of the third reference position of the time points and the fourth reference position of the time points mapped to the global map through the conversion relationship obtained in step S220. For example, the target function is Σₖ₌₀^{TP}ΔDistance, where TP is the number of time points and ΔDistance is the miss distance. Taking FIG. 7A and FIG. 7B as an example, TP is 3, k=0 corresponds to time point t1, k=1 corresponds to time point t2, and k=2 corresponds to time point t3. In addition, Arg min (Σₖ₌₀^{TP}ΔDistance) is used to obtain the optimal solution for minimizing the sum of the miss distances of multiple time points (e.g., the values of θ, Tx, and Ty).

In one embodiment, the processor 13 may execute the correction of step S230 periodically or based on events, so as to provide a more accurate conversion relationship.

In one embodiment, based on the corrected conversion relationship, the processor 13 may use the object tracking technology to track the subsequently detected objects. For multiple continuous images or videos, (multi) object tracking technology may be used. The main function of object tracking is to track the same object framed in consecutive frames. There are also many algorithms for object tracking, such as optical flow, SORT (simple online and realtime tracking) or Deep SORT, and joint detection and embedding (JDE). The processor 13 may map the image coordinates of the reference position of the object in the image to the global map through the corrected conversion relationship, so as to obtain the coordinates of the object on the global map. Then, the processor 13 may continue to track the same object in other frames according to the coordinates on the global map.

In one embodiment, based on the corrected conversion relationship, the processor 13 may obtain other exercise information, such as speed, acceleration, or rotation angle. The processor 13 may calculate the exercise information according to the coordinates on the global map based on the corrected conversion relationship. For example, moving speed and acceleration are determined based on the coordinates of multiple frames.

In one embodiment, taking the application scenario in FIG. 4A as an example, the embodiment of the disclosure may also be applied to the bird eye view of the advanced driver-assistance system (ADAS). For example, according to the coordinates on the global map based on the corrected conversion relationship, the object O4 is marked in the views around the mobile vehicle V or visual cues corresponding to relative distances may be provided. For another example, the satellite positioning coordinates of the object O4 is determined according to the satellite positioning coordinates of the mobile vehicle V and the coordinates on the global map.

It is worth noting that since the embodiment of the disclosure directly matches the relative position relationship of different local maps, the image capturing devices 21 and 22 have fewer restrictions on configuration positions. For example, the image capturing devices 21 and 22 may be configured in the mobile vehicle V shown in FIG. 4A.

To sum up, in the association matching method and the association matching system in the embodiment of the disclosure, the reference coordinates on the local map in the images from two image capturing devices are mapped to a single global map, and the conversion relationship for the mapping is corrected. In this way, the visual feature discrepancies caused by hardware and viewing angle differences between the cameras may be avoided, which may also be applied in scenarios involving mobile vehicles.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An association matching method, comprising:
determining first reference coordinates of a first reference position in a first image on a first local map, determining second reference coordinates of a second reference position in a second image on a second local map, wherein the first image is obtained through a first image capturing device, and the second image is obtained through a second image capturing device;
mapping the first local map and the second local map to a global map, wherein at least one of the first reference coordinates of the first reference position and the second reference coordinates of the second reference position is mapped to coordinates on the global map according to a conversion relationship; and
correcting the conversion relationship according to coordinates of a third reference position in at least one third image and a fourth reference position in at least one fourth image mapped to the global map through the conversion relationship, wherein the at least one third image is obtained through the first image capturing device, the at least one fourth image is obtained through the second image capturing device, and a corrected conversion relationship minimizes a miss distance between the coordinates of the third reference position mapped to the global map and the coordinates of the fourth reference position mapped to the global map.

2. The association matching method according to claim 1, wherein steps for correcting the conversion relationship comprise:
defining a target function according to the miss distance; and
minimizing the target function to determine the corrected conversion relationship.

3. The association matching method according to claim 2, wherein the at least one third image comprises third images of a plurality of time points, the at least one fourth image comprises fourth images of the time points, and a step for defining the target function according to the miss distance comprises:
defining the target function according to a sum of the miss distance between two coordinates of the third reference position of the time points and the fourth reference position of the time points mapped to the global map.

4. The association matching method according to claim 1, wherein steps for correcting the conversion relationship comprise:
identifying an object in the at least one third image and the at least one fourth image; and
defining a position of the object in the at least one third image as the third reference position, and defining a position of the object in the at least one fourth image as the fourth reference position.

5. The association matching method according to claim 1, wherein steps for mapping the first local map and the second local map to the global map comprise:
defining the first local map as a reference map; and
determining the conversion relationship of the second reference coordinates converting to the first reference coordinates on the reference map.

6. The association matching method according to claim 1, wherein the conversion relationship is a conversion matrix, and the conversion matrix is adapted to perform at least one of rotation and translation on the coordinates.

7. The association matching method according to claim 1, further comprising:
defining that a field of view of the first image capturing device partially overlaps a field of view of the second image capturing device.

8. The association matching method according to claim 7, wherein the second image capturing device is located in the field of view of the first image capturing device, and the first image capturing device is located in the field of view of the second image capturing device.

9. The association matching method according to claim 7, wherein the second image capturing device is not located in the field of view of the first image capturing device, and the first image capturing device is not located in the field of view of the second image capturing device.

10. The association matching method according to claim 1, wherein a step for determining the first reference coordinates of the first reference position in the first image on the first local map comprises:
converting pixel coordinates of the first reference position in the first image to the first reference coordinates through a pinhole camera model.

11. An association matching system, comprising:
a computing device for executing:
determining first reference coordinates of a first reference position in a first image on a first local map, determining second reference coordinates of a second reference position in a second image on a second local map, wherein the first image is obtained through a first image capturing device, and the second image is obtained through a second image capturing device;
mapping the first local map and the second local map to a global map, wherein at least one of the first reference coordinates of the first reference position and the second reference coordinates of the second reference position is mapped to coordinates on the global map according to a conversion relationship; and
correcting the conversion relationship according to coordinates of a third reference position in at least one third image and a fourth reference position in at least one fourth image mapped to the global map through the conversion relationship, wherein the at least one third image is obtained through the first image capturing device, the at least one fourth image is obtained through the second image capturing device, and a corrected conversion relationship minimizes a miss distance between the coordinates of the third reference position mapped to the global map and the coordinates of the fourth reference position mapped to the global map.

12. The association matching system according to claim 11, wherein the computing device executes:
defining a target function according to the miss distance; and
minimizing the target function to determine the corrected conversion relationship.

13. The association matching system according to claim 12, wherein the at least one third image comprises third images of a plurality of time points, the at least one fourth image comprises fourth images of the time points, and the computing device executes:
defining the target function according to a sum of the miss distance between two coordinates of the third reference position of the time points and the fourth reference position of the time points mapped to the global map.

14. The association matching system according to claim 11, wherein the computing device executes:
identifying an object in the at least one third image and the at least one fourth image; and
defining a position of the object in the at least one third image as the third reference position, and defining a position of the object in the at least one fourth image as the fourth reference position.

15. The association matching system according to claim 11, wherein the computing device executes:
defining the first local map as a reference map; and
determining the conversion relationship of the second reference coordinates converting to the first reference coordinates on the reference map.

16. The association matching system according to claim 11, wherein the conversion relationship is a conversion matrix, and the conversion matrix is adapted to perform at least one of rotation and translation on the coordinates.

17. The association matching system according to claim 11, wherein the computing device executes:
defining that a field of view of the first image capturing device partially overlaps a field of view of the second image capturing device.

18. The association matching system according to claim 17, comprising:
the first image capturing device and the second image capturing device, wherein the second image capturing device is located in the field of view of the first image capturing device, and the first image capturing device is located in the field of view of the second image capturing device.

19. The association matching system according to claim 17, comprising:
the first image capturing device and the second image capturing device, wherein the second image capturing device is not located in the field of view of the first image capturing device, and the first image capturing device is not located in the field of view of the second image capturing device.

20. The association matching system according to claim 11, wherein the computing device executes:
converting pixel coordinates of the first reference position in the first image to the first reference coordinates through a pinhole camera model.
